(19) United States
(12) Patent Application Publication
(10) Pub. No.: US 2004/0260630 A1
(43) Pub. Date: Dec. 23, 2004

(54) Network support for mobile service plan cumulative usage reports

(76) Inventors: David S. Benco, Winfield, IL (US); Sandra Lynn True, St. Charles, IL (US)

Correspondence Address: Werner Ulrich, 434 Maple Street, Glen Ellyn, IL, 60137, US

(21) Appl. No.: 10/601,107

(22) Filed: Jun. 20, 2003

(51) Int. Cl. G06F 17/60

(52) U.S. Cl. 705/30

(57) ABSTRACT

Apparatus and a method for providing mobile telephone subscribers with data on accumulated usage. Most billing plans provide a subscriber with a basic number of minutes of usage (frequently separate off-peak and peak period usage) and then charge a relatively high amount for any excess use. In accordance with this invention, a mobile switching center and its associated subscriber database keep track of the accumulated usage by category of the mobile telephone over the course of a billing period (typically one month). Subscribers are warned if their accumulated usage threatens to exceed or exceeds the allowable basic usage of their billing plan. Advantageously, mobile telephone subscribers receive warnings of pending overflow on their usage so that they can either restrain their usage if it is likely that they will exceed the limits of their billing plan or they can upgrade their service plan to more closely match their typical usage habits.

### TECHNICAL FIELD

This invention relates to a method and apparatus for reporting cumulative usage to mobile telephone subscribers for each billing period.

### BACKGROUND OF THE INVENTION

Most mobile telephone billing plans charge subscribers a flat rate for some initial quantity of usage (e.g. minutes for voice usage, number of packets for data usage) and a per minute rate for any excess voice usage or a per packet rate for any excess data transmission usage. In many service plans, a distinction is made between usage during “peak” periods (typically office hours or extended office hours) and off peak periods, with a much larger allowance of time for the off peak period. In the case of voice usage, the charge for extra minutes of use is frequently much higher than the average charge per minute for the minutes included in the subscriber's service plan.

Many cellular phones currently provide a mobile-centric function for tracking minutes used. This counter can be manually reset by the subscriber at any time; there is no concept of automatic re-initialization of said counter based on the mobile subscriber's billing cycle. There is no differentiation between categories of usage (e.g. peak voice minutes versus off-peak voice minutes, peak data usage versus off-peak data usage.)

A problem of the prior art is that subscribers do not normally keep track of how many minutes of usage they have accumulated during the monthly billing period and are often surprised by high extra usage charges in the event that they go over their basic service package allowance by a substantial number of minutes in the case of voice usage, or a substantial number of packets in the case of data transmission usage.

### SUMMARY OF THE INVENTION

The above problem is solved and an advance is made over the teachings of the prior art in accordance with this invention wherein a mobile switching center keeps track of the accumulated usage by usage category for a subscriber over the course of the billing period (usually a month) and reports this usage to the subscriber at times that the subscriber is most likely to want such reports. Advantageously, a subscriber is warned of potential overcharges if the usage meets a subscriber-defined threshold or thresholds which relate to the allotted usage defined for the subscriber's billing plan. In addition, a subscriber is able to negotiate a trade of usage by category for a particular billing cycle based on a service provider's pre-defined exchange rate.

In accordance with one set of features of Applicants' invention, current usage reports can be provided whenever the subscriber powers up the mobile, whenever an incoming call is received, whenever an outgoing call is initiated, whenever any call, either incoming or outgoing, is completed, or when the subscriber manually requests a report. The report, for example, in the case of voice minutes, would indicate how many minutes of usage by category (peak usage versus off-peak usage) have already been accumulated in the current billing cycle. This usage information can be reported as the number of minutes used and/or the percentage of the minutes used by category as compared to the number of minutes provided by category under the subscriber's billing plan. In accordance with another feature of Applicants' invention, subscribers have the ability to optionally choose the conditions for automatic usage reporting and subsequently change the reporting condition so that, for example, reports are only provided when the subscriber powers on the mobile phone and when a call is completed.

In accordance with another feature of Applicants' invention, the usage reports can be provided through a display if the subscriber's mobile telephone has sufficient display capabilities or through a system generated verbal announcement.

In accordance with another feature of Applicants' invention, subscribers have the ability to define one or more usage threshold values by usage category for which the telecommunications network will keep track of and determine when the actual subscriber usage by category transgresses at least one subscriber-defined usage threshold; and effecting, by the telecommunications network via an SMS (short message service) message, a voice message, or a display message sent to the mobile, a warning notice of the transgression of the at least one subscriber-defined usage threshold by category.

In accordance with another feature of Applicants' invention, the subscriber will be able to negotiate with the telecommunications network, a trade of usage by category for a particular billing cycle, based on a service provider's pre-defined exchange rate. For example, a subscriber may be able to trade 100 unused off-peak voice minutes for 10 minutes of peak voice minutes.

### BRIEF DESCRIPTION OF THE DRAWING(S)

FIG. 1 is a block diagram illustrating the operation of Applicants' invention; and

FIGS. 2-5 are flow diagrams illustrating the method of Applicants' invention.

### DETAILED DESCRIPTION

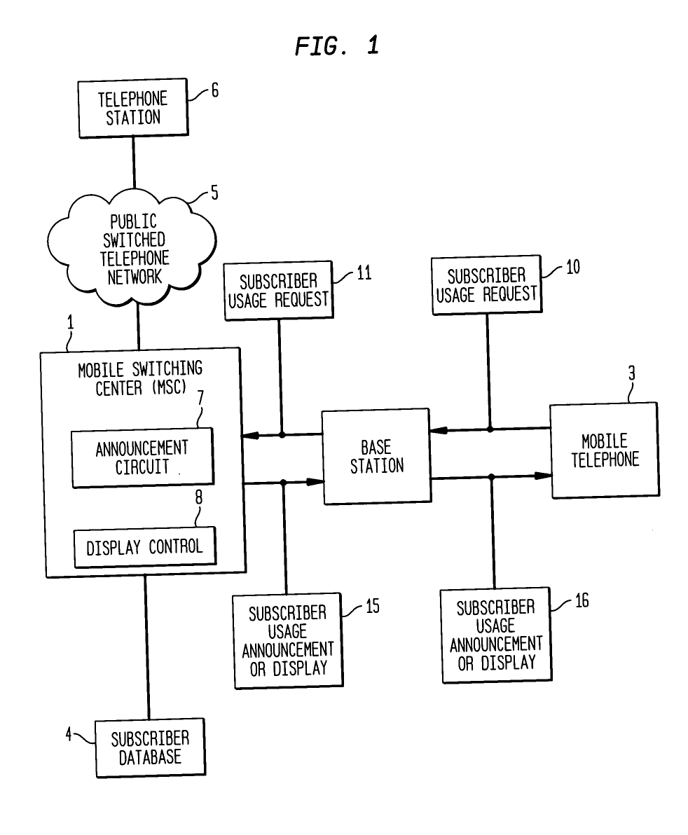

FIG. 1 is a block diagram illustrating the operation of Applicants' invention. A mobile telephone 3 is to be connected, for example, to a land based telephone 6. The mobile telephone is connected to a controlling switch, the mobile switching center (MSC) 1, via a base station 2, which communicates with a mobile telephone by radio and communicates with a mobile switching center by landline facilities. The mobile switching center communicates with telephone stations not served by the MSC such as telephone station 6 via the public switched telephone network (PSTN) 5. For calls from outside the MSC, e.g., from telephone stations such as station 6, the same path is used. The mobile switching center 1 also communicates with a subscriber database 4, which for the purposes of this invention, maintains a record of the usage by the subscriber. This record is maintained separately for peak period usage and off-peak period usage. The record is accumulated over the course of the billing period, i.e., over the course of the (typically) one-month billing period. After each call, the accumulated number of minutes for the call is transmitted to the subscriber database from the mobile switching center and the subscriber database updates its cumulative record.

The mobile switching center also has announcement circuit 7 for generating announcements to be transmitted to a mobile station and a display control circuit 8 for sending data for controlling a display of the mobile station.

For the purposes of this invention, a mobile station 3 sends a usage report request 10. The usage request may be inherent in a power on registration request or it may be a special message. The usage request is passed to base station 2 which forwards it as a usage request 11 to the mobile switching center. The mobile switching center returns a usage announcement or display message 15 to the base station, which forwards this usage announcement or display data 16 to the mobile station.

The subscriber database maintains for each subscriber who uses this reporting system a record of the service plan type; a record of the start date of the billing cycle; a record of the peak minutes available on the current calling plan for voice communications; a record of the off-peak minutes available on the current calling plan (for voice communications); a record of the peak usage in number of packets allowed on the current calling plan for data; a record of the off-peak usage in number of packets allowed on the current calling plan for data; a record of the minutes and/or packets already used in the current billing cycle by category; and a record of usage thresholds by category for automatically warning subscriber of potential usage transgressions.

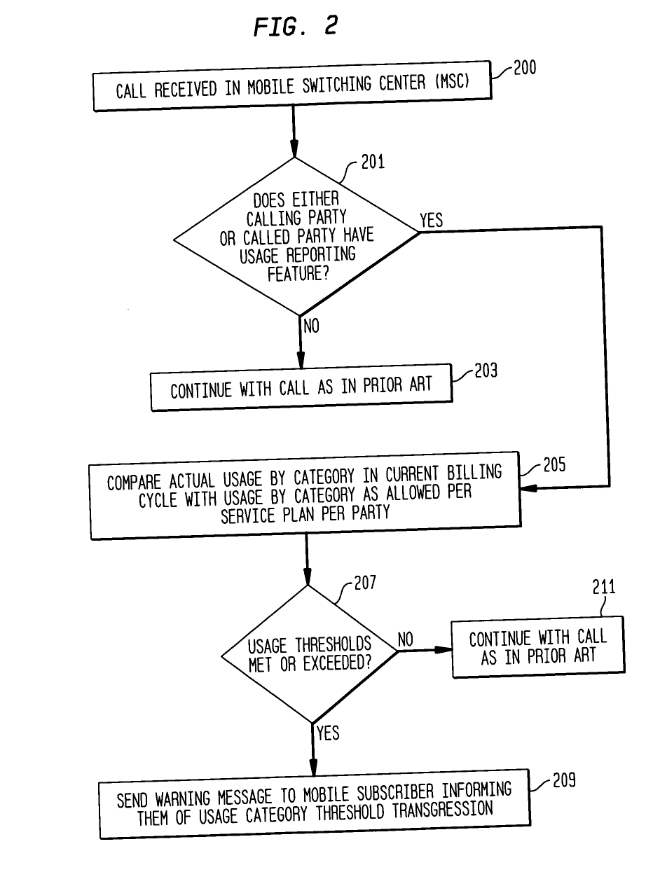

FIG. 2 is a flow diagram illustrating the operation of Applicants' invention for accumulating actual usage and reporting a usage threshold transgression. A call is received at the mobile switching center (MSC) (action block 200). Test 201 is used to determine whether the calling party or the called party has the usage-reporting feature. If not, then the call is continued as in the prior art (action block 203). If either party does have the usage-reporting feature then the actual usage for this category of call type in the current billing cycle is compared with the usage allowed for this category of call type in the service plan (action block 205). Test 207 is used to determine whether the usage thresholds have been met or exceeded. The usage threshold can be a fixed number, e.g., 80% of the total allowed, or it can be a percentage of the number of minutes, which, on a linear basis, would lead to the accumulation of the allowed limit, or both. If the usage threshold has not been met or exceeded, then the call is continued as in the prior art (action block 211). If the threshold has been met or exceeded, then a warning message is sent to the subscriber informing them of the usage by category for the usage category that has been exceeded. (action block 209). The message is either in the form of a voice announcement, an SMS message sent to the mobile, or data for displaying at the mobile telephone station.

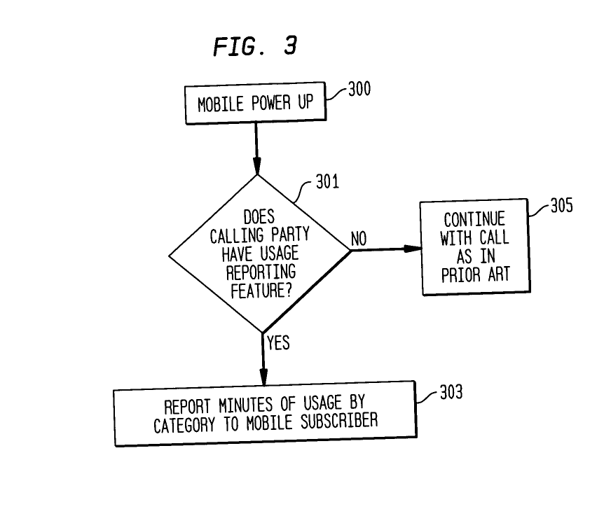

FIG. 3 is a flow diagram showing the response to the powering up of a mobile station. The mobile station is powered up (action block 300). Test 301 is used to determine whether the calling party has the usage reporting feature. If not, then the call is continued as in the prior art (action block 305). If the calling party does have the usage-reporting feature, then the minutes of usage by category is reported to the subscriber (action block 303). In this particular example, the subscriber receives an informational usage report on powering up if they have selected this option. In other embodiments, the subscriber may receive a warning report on power up only if a subscriber-defined usage threshold has been met or exceeded.

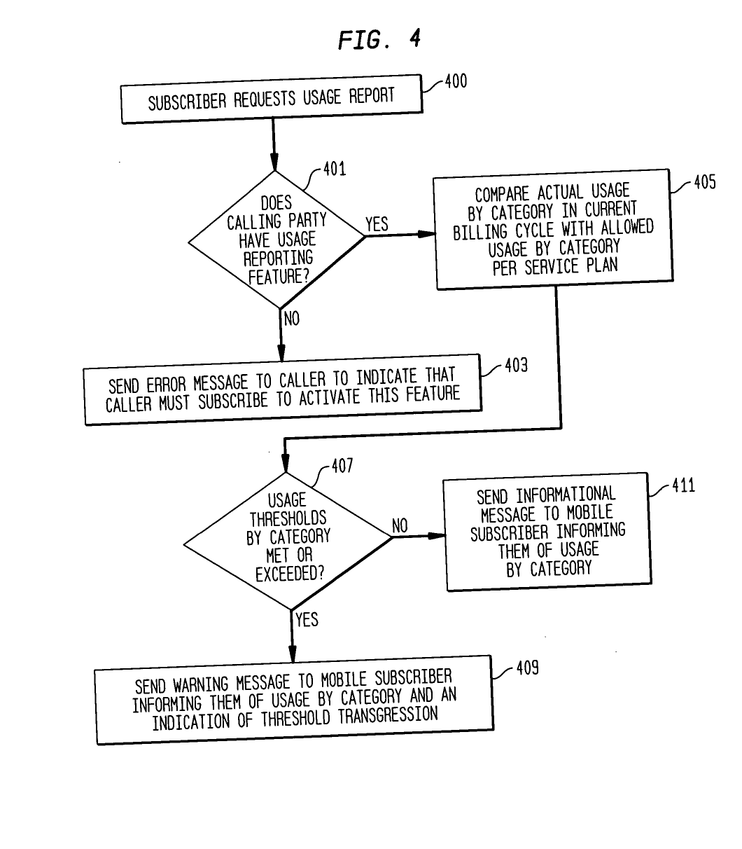

FIG. 4 is a flow diagram illustrating the system response to a subscriber request for a usage report. The subscriber makes such a request (action block 400). Test 401 is used to determine whether the calling party has a usage-reporting feature. If not, then an error message is sent to the calling party to indicate that the calling party must subscribe to activate this feature (action block 403). If the calling party has the feature, then the actual usage by category in the current billing cycle is compared with the allowed usage by category per the service plan (action block 405). Test 407 is used to determine whether the usage thresholds by category have been met or exceeded. If so, then a warning message is sent to the mobile subscriber informing them of the minutes used by category, possibly accompanied by percentage of allowed minutes (action block 409). If the usage thresholds have not been met or exceeded, then an informational message is sent to the mobile subscriber informing them of actual usage by category as compared to allowed usage by category per service plan (action block 411).

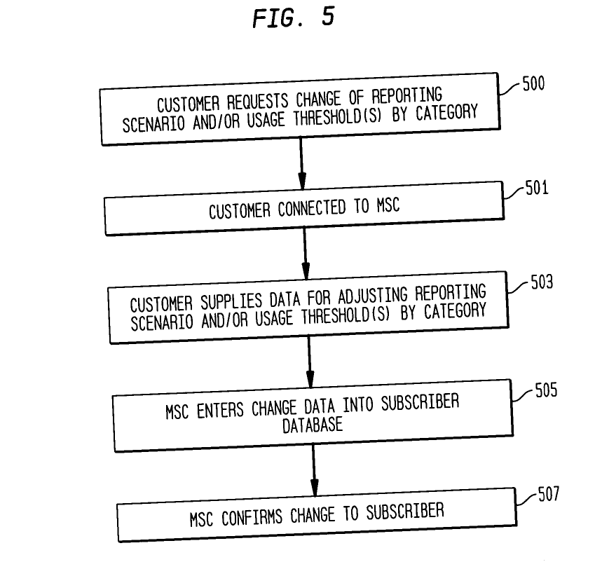

FIG. 5 is a flow diagram illustrating the control of the reporting arrangements by a mobile subscriber. It is assumed that the mobile subscriber has already been registered to receive the service. The registration process is likely to be one that goes through the administration system of the carrier. A subscriber requests a change of the reporting scenario(s) or usage threshold(s) by category (action block 500). The subscriber is connected to the mobile switching center (action block 501). The subscriber supplies data for adjusting the reporting scenarios and/or usage threshold(s) by category (action block 503). The MSC enters the change data into the subscriber database (action block 505). The MSC then confirms the change to the subscriber (action block 507).

The above description is of one preferred embodiment of Applicants' invention. Other embodiments will be apparent to those of ordinary skill in the art without departing from the scope of the invention. The invention is only limited by the attached claims.

We claim:

1. In a mobile switching system a method of providing usage information to a mobile user comprising the steps of:
storing for said user an indication of a billing plan of said user;
responsive to use by said user of said mobile switching system for a call, incrementing a count of accumulated time for a duration of said call;
informing said user of said accumulated time; and
resetting said accumulated time record at an end of a billing cycle for said customer.

2. The method of claim 1 wherein said billing plan comprises separate peak and off peak periods with separate allotments of minutes or packets for each type of period.

3. The method of claim 2 wherein the step of informing said user comprises the step of informing said user on one or more of:
powering on a station of said user;
before or after each incoming or outgoing call to or from said user; and
upon request by said user.

4. The method of claim 3 further comprising the step of:
said user controlling arrangements for when said user is informed.

5. The method of claim 1 further comprising the steps of:
maintaining threshold parameters for minutes of use or data packets transmitted, for use in determining when said user has exceeded a threshold of use; and
informing said user of an exceeding of said threshold.

6. The method of claim 5 further comprising the step of said customer controlling said threshold parameters.

7. The method of claim 1 wherein said informing is performed by an announcement, a display, or a short message service message provided to said user.

8. In a mobile switching system, apparatus for providing usage information to a mobile user comprising:
means for storing for said user an indication of a billing plan of said user;
means, responsive to use by said user of said mobile switching system for a call, for incrementing a count of accumulated time for a duration of said call;
means for informing said user of said accumulated time; and
means for resetting said accumulated time record at an end of a billing cycle for said customer.

9. The apparatus of claim 8 wherein said billing plan comprises separate peak and off peak periods with separate allotments of minutes or packets for each type of period, and wherein separate counts of accumulated time are maintained for peak and off peak periods.

10. The apparatus of claim 9 wherein the means for informing said user comprises means for informing said user on one or more of:
powering on a station of said user;
before or after each incoming or outgoing call to or from said user; and
upon request by said user.

11. The apparatus of claim 10 further comprising:
means for permitting said user to control arrangements for when said user is informed.

12. The apparatus of claim 8 further comprising:
means for maintaining threshold parameters for minutes of use or data packets transmitted, for use in determining when said user has exceeded a threshold of use; and
means for informing said user of an exceeding of said threshold.

13. The apparatus of claim 12 further comprising:
means for permitting said customer to control said threshold parameters.

14. The apparatus of claim 8 wherein said means for informing comprises means for providing an announcement, a display, or a short message service message to said user.
